(19) United States
(12) Patent Application Publication
(10) Pub. No.: US 2007/0044670 A1
(43) Pub. Date: Mar. 1, 2007

(54) Spray bar control for accomodating multiple widths

(75) Inventors: Ken Francis Blaney, Rochester, NH (US); Michael Thomas Woroniak, Rochester, NH (US); Michael Robert Lemelin, Madbury, NH (US)

Correspondence Address: DAVIDSON, DAVIDSON & KAPPEL, LLC, 485 SEVENTH AVENUE, 14TH FLOOR, NEW YORK, NY, 10018, US

(73) Assignee: Goss International Americas, Inc., Dover, NH (US)

(21) Appl. No.: 11/210,039

(22) Filed: Aug. 23, 2005

(51) Int. Cl. B41L 25/00

(52) U.S. Cl. 101/148

(57) ABSTRACT

An apparatus and method in accordance with the invention for accommodating multiple web widths by controlling fluid flow from a spray bar. Specifically, the apparatus and method receives a request for a reduced web width and controls one or more outside spray nozzles of the spray bar to spray at a reduced flow rate.

### CROSS-REFERENCE TO RELATED APPLICATIONS

This application is related to IMPROVED SPRAY PATTERN VALVE BODY, U.S. application Ser. No. [to be assigned, attorney docket no. 6003.1025] and CENTRAL MANIFOLD SUPPLY FOR SPRAY BAR, U.S. application Ser. No. [to be assigned, attorney docket no. 6003.1024], the entire disclosures of which are hereby incorporated by reference.

### FIELD OF THE INVENTION

The invention relates to printing presses and more particularly to a spray bar and method for operating the same.

### BACKGROUND

Spray bars having multiple spray heads are used in the printing industry to deliver a fluid, such as a fountain solution to a dampener roll which transmits the solution to the plate via several other dampener rolls. A typical spray bar is designed to accommodate the width of a web. If it is desired to run a reduced web width, shutters are attached to the spray bar. Shutters work by truncating the spray pattern of the two spray heads at either end of the spray bar. Typical shutters have multiple settings so the spray bar can run a number of reduced web widths.

Early shutter designs consisted of a solid blade which did not allow any fluid to reach the ends of the target roll in the truncated region of the spray pattern. This caused premature failure of the roll due to excessive heat generation in the non-wetted area. Another problem with using shutters is that below a certain web length the shutters become ineffective. The effectiveness of shutters is subject to a limited web width range. The use of shutters results in increased waste since a portion of the truncated spray pattern is directed into the drain pan instead of onto the roll.

More recent shutter designs have been perforated in order to allow a portion of the spray pattern in the truncated region to pass through the shutter to the target roll. This wets the roll enough to prevent premature damage to the roll. Multiple pairs of shutters are sometimes provided to accommodate a greater web width variation.

### SUMMARY OF THE INVENTION

In accordance with an embodiment of the present invention, a spray bar control apparatus and method is provided which accommodate multiple web widths. The apparatus and method receives a request for a reduced web width and controls one or more outside spray nozzles of the spray bar to spray at a reduced flow rate. In this regard, the rate is referred to as a “reduced flow rate” because it is a lower flow rate than the flow rate used when there is not a reduced web width request.

In accordance with another embodiment of the present invention, a printing unit is provided. The printing unit includes a plurality of spray nozzles arranged axially across a dampener roll to spray a fluid on to a printing plate on the plate cylinder of the printing unit. An interface is provided for communicating with the spray bar, and a processor connected to the interface. The processor is responsive to a request for a reduced web width value, the processor controlling one or more outside spray nozzles of the plurality of spray nozzles to spray at a reduced rate.

Methods for controlling fluid flow from the plurality of spray nozzles described above are also provided.

### BRIEF DESCRIPTION OF THE DRAWINGS

Further features and advantages of the invention will become apparent from the following detailed description taken in conjunction with the accompanying drawings, in which:

FIG. 1 illustrates a spray bar in accordance with an embodiment of the present invention;

FIG. 2 illustrates a controller in accordance with an embodiment of the present invention; and

FIG. 3 is a flow chart illustrating a process for controlling reduced web widths of the spray bar in accordance with an embodiment of the present invention.

### DETAILED DESCRIPTION

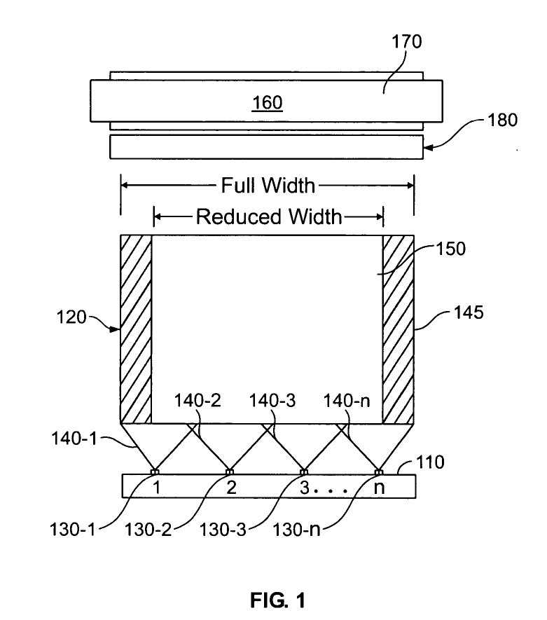

FIG. 1 illustrates a spray bar 110 and spray pattern 120 in accordance with an embodiment of the present invention which truncates a spray pattern generated from spray nozzles of the spray bar. As shown in FIG. 1, spray bar 110 includes spray nozzles 130-1 through 130-n and spray patterns 140-1 through 140-n, where n is a predetermined number greater than 1. Not shown in FIG. 1, for ease of illustration, is a solenoid in each spray head associated with each spray nozzle for controlling the delivery of fluid through spray nozzles 130-1 through 130-n.

In the illustrated embodiment of FIG. 1, n equals 4. Thus, spray bar 110 has 4 spray nozzles 130-1 through 130-4 and 4 spray patterns 140-1 through 140-4. Spray bar 110 is connected to a fluid source and source line (both not shown). The fluid can be for example a solution, such as a fountain solution used in a dampening system in a printing unit of a printing press which flows from the source and through the source line and spray bar 110. After entering spray bar 110, the fluid enters and exits spray nozzles 130-1 through 130-4 onto, for example, a dampener roll which transmits the fluid to one or more further dampener rolls (collectively, dampener roll arrangement 180) which in turn transmits fluid onto a printing plate(s) 170 of a plate cylinder 160. For example, as illustrated schematically in FIG. 1, the spray nozzles 130 are arranged axially across a plate cylinder 160 to spray a fluid on to a printing plate 170 on the plate cylinder 160 of a printing unit via the axially extending dampener rolls of the dampener roll assembly 180. Although a single spray bar and plate cylinder is described herein, it should be appreciated that a printing unit may include a plurality of plate cylinders, each having a respective spray bar.

The spray nozzles may be controlled, for example, via solenoids, and the flow rate can be increased or decreased by respectively increasing or decreasing the solenoid frequency or pulse width (on-time). Preferably, the solenoids form part of a solenoid valve in spray nozzle.

Also shown in FIG. 1 is spray pattern 120. Spray pattern 120 shows a first, full web width 145 and a second, reduced web width 150. Web width 145 is the result of fluid flowing through spray nozzles 130-1 through 130-4. Reduced web width 150 is the result of fluid flowing through spray nozzles 130-1 through 130-4 in accordance with an embodiment of the present invention.

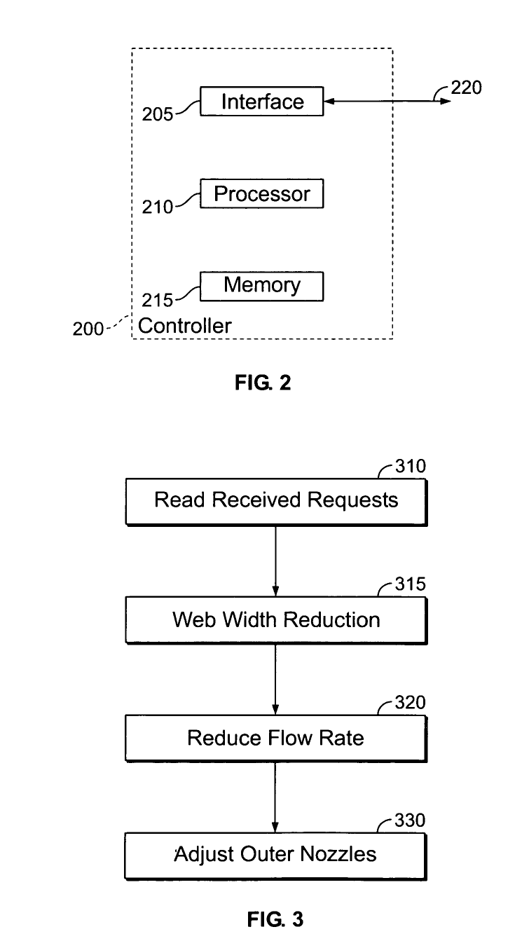

In accordance with embodiments of the present invention, a printing press automatically adjusts the spray bar(s) for a reduced web width. Referring to FIG. 2, a controller 200 includes processor 210 of conventional design, which is connected to memory 215 and interface 205. In accordance with the invention processor 210 receives, from a user interface, a request for a particular reduced web width 150, via interface 205 and communications bus 220. Also received by processor 210 is a value representing the full web width 145. Such requests are processed by processor 210 in accordance with a program stored in memory 215 which is described below. In response to such request, processor 210 causes outside spray nozzles 130-1 and 130-4 of spray bar 110 to spray at a reduced flow rate for reduced web width 150.

Instructed by the program, processor 210 reads the received request for the reduced web width, as indicated by block 310 in FIG. 3. At block 315, processor 210 determines a percentage web width reduction based on the full web width and the requested reduced web width, where % Web Width Reduction is denoted as X. In short,

$$X = \% Web Width Reduction = \frac{( \begin{matrix}Reduced Web Width - \\ Full Web Width\end{matrix} )}{Full Web Width}$$

At block 320, processor 210 determines a reduced flow rate for the outer spray nozzles 130-1 and 130-n. The reduced flow rate is determined using the following equation:
Flow Rate(Nozzle #)=q(1−X/2), where
#=Spray Nozzle Position, and
q=Flow Rate Per Nozzle For Full Web Width.

As mentioned above, processor 210 determines the reduced flow rate for spray nozzles 130-1 and 130-n, shown below:
Flow Rate(Nozzle 1)=q(1−X/2).
Flow Rate(Nozzle n)=q(1−X/2).

The interior Nozzles (Nozzles 2-(n−1)) are maintained at the flow rate used for the full web width:
Flow Rate(Nozzle 2, 3 . . . (n−1))=q, where
n=Number Of Nozzles Across Spray Bar

Because n=4 in this illustration (i.e. spray heads 130-1 through 130-4), there are 2 spray heads (inside spray heads) that are maintained at a flow rate for the full web width as indicated below:
Flow Rate(Nozzle 2, 3)=q
and the spray heads maintained at the reduced flow rate are:
Flow Rate(Nozzle 1, 4)=q(1−X/2)

At block 330, processor 210 sends a control signal to the solenoids of spray nozzles 130-1 and 130-4 to proportionally reduce the flow rate by decreasing solenoid frequency, while maintaining the full web width flow rates of spray nozzles 130-2 and 130-3, thus producing the reduced web width 150, as illustrated in FIG. 1.

The foregoing merely illustrates the principles of the invention. It will thus be appreciated that those skilled in the art will be able to devise numerous other arrangements which embody the principles of the invention and are thus within its sprit and scope.

For example, based on the above disclosure, it is apparent that the principles of the invention can readily accommodate more or less spray nozzles to achieve the benefits of the invention.

Finally, the system and method are disclosed above in a form in which various functions are performed by discrete functional blocks. However, any one or more of these functions could equally well be embodied in an arrangement in which the functions of any one or more of those blocks or indeed, all of the functions thereof, are realized, for example, by one or more appropriately programmed processors such as digital signal processors (DSPs), microcontroller, microprocessor or system on a chip. Thus, for example, controller 200 may be realized by one or more DSPs, microcontrollers, microprocessors or system on a chip and/or a combination of digital logic devices and other components running a software program or having functions programmed in firmware.

What is claimed is:

1. An apparatus for controlling fluid flow from a spray bar comprising:
an interface for communicating with the spray bar; and
a processor connected to the interface responsive to a request for a reduced web width value, the processor controlling one or more outside spray nozzles of the spray bar to spray at a reduced flow rate.

2. A printing unit, comprising:
a plurality of spray nozzles, the spray nozzles arranged axially across a dampener roll of the printing unit;
an interface for communicating with the spray bar;
a processor connected to the interface responsive to a request for a reduced web width value, the processor controlling one or more outside spray nozzles of the plurality of spray nozzles to spray at a reduced rate.

3. The printing unit of claim 2, wherein the spray nozzles are part of a spray bar.

4. The printing unit of claim 2 wherein the processor controls each of the plurality of spray nozzles, and wherein, in response to the request, the processor maintains one or more inside spray nozzles of the plurality of spray nozzles at a flow rate that is greater than the reduced flow rate.

5. The printing unit of claim 2 wherein the processor determines a percentage web width reduction value based on a full web width value and the reduced web width value.

6. The printing unit of claim 2 wherein the processor determines a reduced flow rate for the one or more outside spray nozzles to operate.

7. The printing unit of claim 2 wherein the processor determines a number of spray nozzles that are to maintain a flow rate for a full web width.

8. The printing unit of claim 2, wherein the processor determines which one or more outer spray nozzles are to operate at the reduced flow rate.

9. The printing unit of claim 2 wherein the processor sends one or more control signals to control one or more solenoids associated with controlling a flow rate of the one or more outside spray nozzles.

10. The printing unit of claim 8 wherein the one or more signals is an analog or a digital signal.

11. The printing unit of claim 8 wherein the processor proportionally reduces the flow rate by changing one or more frequencies, of the one or more solenoids.

12. The printing unit of claim 8 wherein the processor proportionally reduces the flow rate by changing an on-time of the one or more solenoids.

13. The printing unit of claim 2, further comprising a plate cylinder, wherein the fluid transferred from the dampener roll onto a printing plate mounted on the plate cylinder via one or more further dampener rolls.

14. A method for controlling fluid flow from a spray bar comprising:
receiving a request for a reduced web width value; and
controlling one or more outside spray nozzles of the spray bar to spray at a reduced flow rate.

15. The method of claim 14 further comprising maintaining a flow rate for one or more inside spray nozzles that is greater than the reduced flow rate.

16. The method of claim 14 further comprising determining a percentage web width reduction value based on a full web width value and the reduced web width value.

17. The method of claim 14 further comprising determining a reduced flow rate for the one or more outside spray nozzles to operate.

18. The method of claim 14 further comprising determining a number of spray nozzles that is to maintain a flow rate for a full web width.

19. The method of claim 14 further comprising determining which one or more outer spray nozzles are to operate at the reduced flow rate.

20. The method of claim 14 further comprising sending one or more control signals to control one or more solenoids associated with controlling a flow rate of the one or more outside spray nozzles.

21. The method of claim 20 wherein the one or more signals is an analog or a digital signal.

22. The method of claim 20 further comprising proportionally reducing the flow rate by decreasing one or more frequencies of the one or more solenoids.

23. A method for controlling fluid flow from a plurality of spray nozzles arranged axially across a dampener roll of a printing unit, the method comprising:
receiving a request for a reduced web width value; and
controlling one or more outside spray nozzles of the plurality of nozzles to spray at a reduced flow rate.

24. A printing unit, comprising:
a plurality of spray nozzles, the spray nozzles arranged axially across a plate cylinder to transmit fluid on to a printing plate on the plate cylinder of the printing unit;
an interface for communicating with the spray bar;
a processor connected to the interface responsive to a request for a reduced web width value, the processor controlling one or more outside spray nozzles of the plurality of spray nozzles to spray at a reduced rate.

25. The printing unit of claim 24, further comprising a dampener roll assembly, the spray nozzles transmitting fluid on to the printing plate by spraying fluid onto a dampener roll of the dampener roll assembly, which dampener roll assembly in turn transmits the fluid onto the printing plate.
